(19) United States
(12) Patent Application Publication
(10) Pub. No.: US 2001/0009311 A1
(43) Pub. Date: Jul. 26, 2001

(54) Granules by fluidized bed granulation

(76) Inventors: Georg Assmann, Juechen (DE); Wilfried Raehse, Duesseldorf (DE)

Correspondence Address: James M. Olsen, Connolly, Bove, Lodge & Hutz, P.O. Box 2207, (1220 Market Street), Wilmington, DE, 19899, US

(21) Appl. No.: 09/734,085

(22) Filed: Dec. 11, 2000

(30) Foreign Application Priority Data
Dec. 11, 1999 (DE) 199 59 914.9

(51) Int. Cl. B02C 23/24; B02C 19/00; B07B 4/00; B07B 7/00; C08J 3/12

(52) U.S. Cl. 264/140; 209/138; 209/606; 528/502 R; 528/502 F

(57) ABSTRACT

The problem addressed by the invention was to provide a process for the production of organic granules which would give granules with a minimal dust content. It was found that this problem could be solved by a process for the production of granules in which organic compounds are introduced in the form of a melt into a fluidized bed which has a temperature below the softening temperature of the compounds to be granulated, granulated and optionally dried and in that the granules are discharged from the fluidized bed via a grading stage.

This invention relates to a process for the production of granules intended as a component to be added to detergents/cleaners and to detergents/cleaners containing such granules.

Industrially produced solids which are marketed either as end products or for further processing are generally in the form of powders, flakes or granules. The granules in particular are distinguished by favorable pourability and flowability and by a high bulk density.

Substances which have a melting point or softening point and which do not decompose beyond that point are often marketed in the form of so-called flakes. These flakes can be obtained by allowing a melt of the substances to solidify on a so-called crystallization belt and removing the solid therefrom in the form of a flake-form solid.

Unfortunately, flakes are attended by the disadvantage that they have relatively poor flowability, a low bulk density and a high dust content. The dust can easily be inhaled and can lead to dust explosions, i.e. is undesirable for health and safety reasons.

By virtue of the advantages in terms of storage and transportation and also further processability, the solids are preferably used in the form of granules in many industrial processes. One example of such processes is the production of detergents in granulators, for example in fluidized bed granulators. The resulting products, which are produced either as detergent intermediates or additive components or as actual detergents, are distinguished by high bulk densities and by favorable pouring and flow behavior. In addition, they have the advantage that their particle size distribution is relatively narrow, i.e. their dust content is minimal.

The problem addressed by the present invention was to provide a process for the production of organic granules which would give granules with a minimal dust content.

It has surprisingly been found that organic granules with a minimal dust content can be obtained by introducing melts of these organic substances, optionally in admixture with solid constituents, into a fluidized bed with a temperature below the melting temperature of the compounds to be granulated.

Accordingly, the present invention relates to a process for the production of granules, characterized in that organic compounds are introduced in the form of a melt into a fluidized bed which has a temperature below the softening temperature of the substances to be granulated, granulated and optionally dried and in that the granules are discharged from the fluidized bed via a grading stage.

Suitable organic substances are any organic compounds which have a melting point (softening point) below their decomposition temperature and which can be processed in the form of their melts. Examples are thermoplastic polymers, polyethylene glycols, preferably with a melting point above room temperature, natural and synthetic fats, long-chain fatty acids, long-chain fatty alcohols, paraffins and long-chain nonionic surfactants. These compounds may be granulated individually or in the form of mixtures. Long-chain compounds in the context of the invention are compounds which, through the alkyl moiety, have a softening point above 20° C. and preferably even above 25° C.

Solid constituents may also be added to the melt in a quantity of up to 20%, based on the weight of the melt. These solid constituents may be selected from organic and inorganic substances which are preferably selected according to the application envisaged for the granules produced. In one preferred embodiment, solid particles are introduced into the fluidized bed as “crystallization nuclei”. These solid constituents or solid particles are typically substances which perform a carrier function. If the granules are to be used in detergents, it is particularly preferred if the solid constituents are selected from fine-particle carrier materials which simultaneously perform a builder function in the wash liquor.

Suitable inorganic carrier components are, in particular, alumosilicates, alkali metal sulfates and carbonates. According to the invention, the use of various inorganic carriers in combination with one another, more particularly a combination of alumosilicate and soda (ratio by weight of alumosilicate to soda 1:5 to 5:1, preferably 1:2 to 2:1), as carrier has also proved to be advantageous.

Among the alumosilicates, crystalline alumosilicates—the zeolites—are preferably used. Zeolites preferred as carriers are the zeolites A, P, X, Y and mixtures thereof. The use of zeolite A as a carrier is known from numerous publications. However, zeolite P and faujasite zeolites have a higher oil absorption capacity than zeolite A and may therefore be preferred in granules. In one advantageous embodiment of the invention, at least part of the zeolite used, preferably at least 20% by weight and more preferably all the zeolite consists of faujasite zeolite. In the context of the present invention, the term “faujasite zeolite” characterizes all three zeolites which form the faujasite subgroup of zeolite structure group 4. According to the invention, therefore, zeolite Y and faujasite and mixtures of these compounds may be used besides zeolite X, pure zeolite X being preferred. The zeolite A-LSX described in European patent application EP-A-816 291, for example, may also be used with advantage in the process according to the invention. Zeolite A-LSX corresponds to a co-crystallizate of zeolite X and zeolite A and, in its water-free form, has the formula (M_{2/n}O+M′_{2/n}O). Al₂O₃.zSiO₂, where M and M′ may be alkali and alkaline earth metals and z is a number of 2.1 to 2.6. This product is commercially obtainable under the name of VEGOBOND AX from CONDEA Augusta S.p.A. If zeolite P is used, it can be of advantage to use the zeolite MAP described in European patent EP-B-380 070. The particle sizes of the zeolites used in accordance with the invention are preferably in the range from 0.1 to 100 μm, more preferably in the range from 0.5 to 50 μm and most preferably in the range from 1 to 30 μm, as determined by standard methods for determining particle size.

Organic builder components suitable as carriers are in particular polycarboxylates, for example the polycarboxylic acids usable in the form of their sodium salts, polycarboxylic acids in this context being those carboxylic acids which carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA)—providing its use is not ecologically unsafe—and mixtures thereof. Preferred salts are the salts of the polycarboxylic acids, such as citric acid, adipic acid, succinic acid, glutaric acid, tartaric acid, sugar acids and mixtures thereof, more particularly trisodium citrate.

Other suitable organic carrier materials are polymeric polycarboxylates such as, for example, the alkali metal salts of polyacrylic or polymethacrylic acid, for example those with a relative molecular weight of 500 to 70,000 g/mole. The molecular weights mentioned in this specification for polymeric polycarboxylates are weight-average molecular weights M_{w} of the particular acid form which, basically, were determined by gel permeation chromatography (GPC) using a UV detector. The measurement was carried out against an external polyacrylic acid standard which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification. Particularly suitable polymers are polyacrylates which preferably have a molecular weight of 2,000 to 20,000 g/mole. By virtue of their superior solubility, preferred representatives of this group are the short-chain polyacrylates which have molecular weights of 2,000 to 10,000 g/mole and, more particularly, 3,000 to 5,000 g/mole. Also suitable are copolymeric polycarboxylates, particularly those of acrylic acid with methacrylic acid and those of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weights, based on the free acids, are generally in the range from 2,000 to 70,000 g/mole, preferably in the range from 20,000 to 50,000 g/mole and more preferably in the range from 30,000 to 40,000 g/mole.

In particularly preferred embodiments, mixtures of organic and inorganic carriers may also be used. Irrespective of whether mixtures of various carriers or only one carrier component are/is used, the carrier content in the granules is preferably between 5 and 20% by weight.

In one preferred embodiment of the present invention, the melt is introduced into a fluidized bed through one or more nozzles. If mixtures of several organic substances can be produced, it has proved to be suitable for the individual components to be separately introduced through various nozzles. However, the substances may also be mixed and a melt representing a mixture of various substances may be used. In another preferred embodiment, the individual components are introduced through the various channels of a multicomponent nozzle.

The fluidized bed chamber used in the process according to the invention is normally round. The apparatus may be cylindrical, i.e. may have a constant diameter over its height. Preferred fluidized bed chambers are those in which the fluidizing zone widens conically upwards and only the adjoining settling zone is cylindrical after a conical transition section. The process may be carried out in batches or continuously, irrespective of the design of the fluidized bed chamber. According to the present invention, however, the process is preferably carried out continuously.

To produce the granules by the process according to the invention, the melt is preferably introduced into the fluidized bed through a one-component or multicomponent nozzle or through several nozzles. The carrier component and other solids present, if any, are either introduced pneumatically through blow lines, in which case they are added either before or during spraying of the melt, or are added in the form of a mixture with the melt, the constituents being mixed either before spraying or in the nozzle itself. The nozzle or nozzles and their spraying direction may be arranged as required providing substantially uniform distribution of the liquid components in the fluidized bed is achieved. In one preferred embodiment of the invention, solid constituents are mixed with the melt before spraying and the resulting mixture is “blown” into the fluidized bed through a nozzle.

Preferred fluidized bed granulators have base plates at least 0.15 m in diameter. Particularly preferred fluidized bed granulators have a base plate between 0.4 and 5 m in diameter, for example 1.2 m or 2.5 m in diameter. However, fluidized bed granulators having a base plate larger than 5 m in diameter are also suitable. The base plate may be a perforated plate or a Conidur plate (a product of Hein & Lehmann, Federal Republic of Germany), a wire gauze or a combination plate of a perforated plate covered by a gauze, as described in German patent application DE-A-197 50 424. A Conidur plate in particular is able to support the spin effect of the additional air supply.

The process according to the invention is preferably carried out at fluidizing air flow rates of 1 to 8 m/s and, more particularly, 1.2 to 5.5 m/s. According to the invention, the granules are preferably discharged from the fluidized bed via a grading stage. Grading may be carried out, for example, using a sieve or by a stream of air flowing in countercurrent (grading air) which is controlled in such a way that only particles beyond a certain particle size are removed from the fluidized bed while smaller particles are retained therein. In one preferred embodiment, the air flowing in from below is made up of the unheated grading air and optionally the heated bottom air.

In one preferred embodiment, the bottom air temperature is between 10 and 35° C. and more particularly between 10 and 25° C. In a particularly preferred embodiment, the bottom air temperature is at least 5° C. below the softening temperature of the organic substance. To enable the process to be carried out quickly, the bottom air temperature is preferably more than 10° C. and more particularly even more than 15° C. below the softening temperature because temperatures as low as these accelerate solidification of the substances. The temperature of the fluidizing air as measured about 5 cm above the base plate is preferably also well below the softening temperature of the organic substances. The fluidizing air temperature is preferably more than 10° C. below the softening temperature and, more particularly, even more than 15° C. below the softening temperature of the organic substance. During the granulation process, the fluidizing air becomes heated by taking up the heat of fusion released during solidification. However, the air exit temperature is also preferably below the softening temperature of the granulated organic substances. In one particularly preferred embodiment, the air exit temperature is at least 5° C. below the softening temperature.

Any water present in the starting materials may be removed during the fluidized bed granulation. The water content of the products may be adjusted virtually as required. Drying preferably takes place at the same time as granulation in the fluidized bed.

The bulk densities of the resulting granules depend largely on the granulation conditions and the carrier materials added. Typical bulk densities are in the range from 400 to 1,000 g/l, bulk densities of 550 to 850 g/l being particularly suitable for the use of the granules in detergents.

If the granules are discharged from the fluidized bed against a stream of grading air, as described in EP-B-0 603 207, dust-free granules are obtained, i.e. the granules preferably contain no particles below 50 μm in size and preferably no particles below 100 μm in size. Preferred granules according to the invention have a d₅₀ value of 0.4 to 2.5 mm. In one particularly preferred embodiment (for fine narrow particle size distributions), particles larger than 1.6 mm in size are recycled. This coarse fraction may either be added to the fluidized bed as a solid component after grinding or is remelted and sprayed into the fluidized bed.

In order further to improve their processability and “dosability”, the granules obtained may be powdered with an oil absorption component. As a result of this powdering step using a fine-particle component, the liquids are fixed to the surface of the granules so that the granules are unable to form lumps in storage. The oil absorption component should have an oil absorption capacity of at least 20 g/100 g, preferably of at least 50 g/100 g, more preferably of at least 80 g/100 g, more preferably of at least 120 g/100 g and, in one particular embodiment, of at least 140 g/100 g.

The oil absorption capacity is a physical property of a substance which can be measured by standardized methods. For example, British Standards BS 1795 and BS 3483:Part B7:1982, which both refer to ISO 78715, are available. In these test methods, a weighed sample of the particular substance is applied to a dish and refined linseed oil (density: 0.93 gcm⁻³) is added dropwise from a burette. After each addition, the powder is intensively mixed with the oil using a spatula, the addition of oil being continued until a paste of flexible consistency is obtained. This paste should flow without crumbling. Now, the oil absorption capacity is the quantity of oil added dropwise, based on 100 g of absorbent, and is expressed in mill 100 g or g/100 g, conversions via the density of the linseed oil readily being possible.

The oil absorption component preferably has a small mean particle size because the active surface increases with decreasing particle size. Preferred detergent tablets contain a component with an oil absorption capacity of at least 20 g/100 g which has a mean particle size below 50 pm, preferably below 20 μm and more preferably below 10 μm.

The oil absorption component may be selected from a number of substances. There are many inorganic and organic substances which have a sufficiently large oil absorption capacity. Fine-particle materials obtained by precipitation are mentioned by way of example in this regard. Suitable oil absorption components are, for example, silicates, alumosilicates, calcium silicates, magnesium silicates and calcium carbonate. However, kieselguhr (diatomaceous earth) and fine-particle cellulose fibers or derivatives thereof may also be used in accordance with the invention.

In one particularly preferred embodiment, zeolite, preferably zeolite A, X or P, is introduced into the fluidized bed as powdering material. These powdering materials additionally reduce the tackiness of the moist granules during granulation and thus promote fluidization and drying to form the required product. The particle size of the powdering material is preferably below 10 μm and the granules obtained contain between 1 and 4% by weight of the powdering material. Although this variant can be of advantage for the production of granules by the process according to the invention, it is not absolutely necessary for carrying out the invention.

The granules obtained in accordance with the invention may be directly processed or marketed. It is particularly preferred to use the granules in detergents.

Accordingly, the present invention relates to detergents which contain granules produced in accordance with the invention.

Besides the granules according to the invention, the detergents according to the invention, which may be present as granules, powder-form or tablet-form solids or other shaped bodies, may in principle contain any of the known ingredients typically present in detergents. Preferred detergents according to the invention are granular detergents, more particularly those which are formed by mixing various granules of detergent components.

Key ingredients of the detergents according to the invention are, above all, anionic, nonionic, cationic, amphoteric and/or zwitterionic surfactants.

Suitable anionic surfactants are in particular soaps and those containing sulfate or sulfonate groups. Suitable surfactants of the sulfonate type are preferably C₉₋₁₃ alkyl benzenesulfonates, olefin sulfonates, i.e. mixtures of alkene and hydroxyalkane sulfonates, and the disulfonates obtained, for example, from C₁₂₋₁₈ monoolefins with an internal or terminal double bond by sulfonation with gaseous sulfur trioxide and subsequent alkaline or acidic hydrolysis of the sulfonation products. Other suitable surfactants of the sulfonate type are the alkane sulfonates obtained from C₁₂₋₁₈ alkanes, for example by sulfochlorination or sulfoxidation and subsequent hydrolysis or neutralization. The esters of α-sulfofatty acids (ester sulfonates), for example the α-sulfonated methyl esters of hydrogenated coconut oil, palm kernel oil or tallow fatty acids, which are obtained by a-sulfonation of the methyl esters of fatty acids of vegetable and/or animal origin containing 8 to 20 carbon atoms in the fatty acid molecule and subsequent neutralization to water-soluble monosalts are also suitable. The esters in question are preferably the α-sulfonated esters of hydrogenated coconut oil, palm oil, palm kernel oil or tallow fatty acid, although sulfonation products of unsaturated fatty acids, for example oleic acid, may also be present in small quantities, preferably in quantities of not more than about 2 to 3% by weight. α-sulfofatty acid alkyl esters with an alkyl chain of not more than 4 carbon atoms in the ester group, for example methyl esters, ethyl esters, propyl esters and butyl esters, are particularly preferred. The methyl esters of a-sulfofatty acids (MES) and saponified disalts thereof are used with particular advantage.

Other suitable anionic surfactants are sulfonated fatty acid glycerol esters, i.e. the monoesters, diesters and triesters and mixtures thereof which are obtained where production is carried out by esterification of a monoglycerol with 1 to 3 moles of fatty acid or in the transesterification of triglycerides with 0.3 to 2 moles of glycerol.

Preferred alk(en)yl sulfates are the alkali metal salts and, in particular, the sodium salts of the sulfuric acid semiesters of C₁₂₋₁₈ fatty alcohols, for example cocofatty alcohol, tallow fatty alcohol, lauryl, myristyl, cetyl or stearyl alcohol, or C₁₀₋₂₀ oxoalcohols and the corresponding semiesters of secondary alcohols with the same chain length. Other preferred alk(en)yl sulfates are those with the chain length mentioned which contain a synthetic, linear alkyl chain based on a petrochemical and which are similar in their degradation behavior to the corresponding compounds based on oleochemical raw materials. C₁₂₋₁₆ alkyl sulfates and C₁₂₋₁₅ alkyl sulfates and also C₁₄₋₁₅ alkyl sulfates are particularly preferred from the washing performance point of view. Other suitable anionic surfactants are 2,3-alkyl sulfates which may be produced, for example, in accordance with U.S. Pat. No. 3,234,258 or U.S. Pat. No. 5,075,041 and which are commercially obtainable as products of the Shell Oil Company under the name of DAN®.

The sulfuric acid monoesters of linear or branched C₇₋₂₁ alcohols ethoxylated with 1 to 6 moles of ethylene oxide, such as 2-methyl-branched C₉₋₁₁ alcohols containing on average 3.5 moles of ethylene oxide (EO) or C₁₂₋₁₈ fatty alcohols containing 1 to 4 EO, are also suitable. In view of their high foaming capacity, they are normally used in only relatively small quantities, for example in quantities of 1 to 5% by weight, in detergents.

Other preferred anionic surfactants are the salts of alkyl sulfosuccinic acid which are also known as sulfosuccinates or as sulfosuccinic acid esters and which represent monoesters and/or diesters of sulfosuccinic acid with alcohols, preferably fatty alcohols and, more particularly, ethoxylated fatty alcohols. Preferred sulfosuccinates contain C₈₋₁₈ fatty alcohol molecules or mixtures thereof. Particularly preferred sulfosuccinates contain a fatty alcohol molecule derived from ethoxylated fatty alcohols which, considered in isolation, represent nonionic surfactants (for a description, see below). Of these sulfosuccinates, those of which the fatty alcohol molecules are derived from narrow-range ethoxylated fatty alcohols are particularly preferred. Alk(en)yl succinic acid preferably containing 8 to 18 carbon atoms in the alk(en)yl chain or salts thereof may also be used.

Other suitable anionic surfactants are fatty acid derivatives of amino acids, for example of N-methyl taurine (taurides) and/or of N-methyl glycine (sarcosides). The sarcosides or rather sarcosinates, above all sarcosinates of higher and optionally mono- or poly-unsaturated fatty acids, such as oleyl sarcosinate, are particularly preferred.

Other suitable anionic surfactants are, in particular, soaps which are used, for example, in quantities of 0.2 to 5% by weight. Suitable soaps are, in particular, saturated fatty acid soaps, such as the salts of lauric acid, myristic acid, palmitic acid, stearic acid, hydrogenated erucic acid and behenic acid, and soap mixtures derived in particular from natural fatty acids, for example coconut oil, palm kernel oil or tallow fatty acids.

The anionic surfactants, including the soaps, may be present in the form of their sodium, potassium or ammonium salts and as soluble salts of organic bases, such as mono-, di- or triethanolamine. The anionic surfactants are preferably present in the form of their sodium or potassium salts and, more preferably, in the form of their sodium salts. Anionic surfactants are present in detergents according to the invention in quantities of preferably 1% b weight to 35% by weight and, more preferably, 5% by weight to 30% by weight.

Preferred nonionic surfactants are alkoxylated, advantageously ethoxylated, more particularly primary alcohols preferably containing 8 to 18 carbon atoms and an average of 1 to 12 moles of ethylene oxide (EO) per mole of alcohol, in which the alcohol residue may be linear or, preferably, 2-methyl-branched or may contain linear and methyl-branched residues in the form of the mixtures typically present in oxoalcohols. However, alcohol ethoxylates containing linear residues of alcohols of native origin with 12 to 18 carbon atoms, for example coconut oil, palm oil, tallow fatty alcohol or oleyl alcohol, and an average of 2 to 8 EO per mole of alcohol are particularly preferred. Preferred ethoxylated alcohols include, for example, C₁₂₋₁₄ alcohols containing 3 EO or 4 EO, C₉₋₁₁ alcohols containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 7 EO. The degrees of ethoxylation mentioned are statistical mean values which, for a special product, may be either a whole number or a broken number. Preferred alcohol ethoxylates have a narrow homolog distribution (narrow range ethoxylates, NRE). In addition to these nonionic surfactants, fatty alcohols containing more than 12 EO may also be used, as described above. Examples of such fatty alcohols are (tallow) fatty alcohols containing 14 EO, 16EO, 20EO, 25 EO, 30 EO or40 EO.

The nonionic surfactants also include alkyl glycosides corresponding to the general formula RO(G)ₓ where R is a primary linear or methyl-branched, more particularly 2-methyl-branched, aliphatic radical containing 8 to 22 and preferably 12 to 18 carbon atoms and G stands for a glycose unit containing 5 or 6 carbon atoms, preferably glucose. The degree of oligomerization x, which indicates the distribution of monoglycosides and oligoglycosides and which, as an analytically determined quantity, may also be a broken number, is a number of 1 to 10, preferred values for x being 1.2 to 1.4.

Other suitable nonionic surfactants are polyhydroxyfatty acid amides corresponding to formula (I):

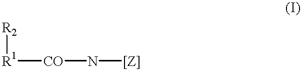

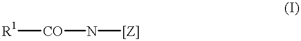

in which R¹CO is an aliphatic acyl group containing 6 to 22 carbon atoms, R² is hydrogen, an alkyl or hydroxyalkyl group containing 1 to 4 carbon atoms and [Z] is a linear or branched polyhydroxyalkyl group containing 3 to 10 carbon atoms and 3 to 10 hydroxyl groups. The polyhydroxyfatty acid amides are preferably derived from reducing sugars containing 5 or 6 carbon atoms, more particularly glucose. The group of polyhydroxyfatty acid amides also includes compounds corresponding to formula (II):

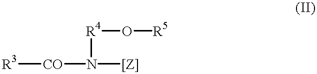

in which R³ is a linear or branched alkyl or alkenyl group containing 7 to 12 carbon atoms, R⁴ is a linear, branched or cyclic alkylene group or an arylene group containing 2 to 8 carbon atoms and R⁵ is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated, derivatives of that group. Here, too, [Z] is preferably obtained by reductive amination of a sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst, for example in accordance with the teaching of International patent application WO-A-95107331.

Another class of preferred nonionic surfactants which are used either as sole nonionic surfactant or in combination with other nonionic surfactants, particularly together with alkoxylated fatty alcohols and/or alkyl glycosides, are alkoxylated, preferably ethoxylated or ethoxylated and propoxylated, fatty acid alkyl esters preferably containing 1 to 4 carbon atoms in the alkyl chain, more particularly the fatty acid methyl esters which are described, for example, in Japanese patent application JP 581217598 or which are preferably produced by the process described in International patent application WO-A-90/13533.

Nonionic surfactants of the amine oxide type, for example N-cocoalkyl-N,N-dimethylamine oxide and N-tallowalkyl-N,N-dihydroxyethyl amine oxide, and the fatty acid alkanolamide type are also suitable. The quantity in which these nonionic surfactants are used is preferably no more, in particular no more than half, the quantity of ethoxylated fatty alcohols used.

Other suitable surfactants are so-called gemini surfactants. Gemini surfactants are generally understood to be compounds which contain two hydrophilic groups per molecule. These groups are generally separated from one another by a so-called “spacer”. The spacer is generally a carbon chain which should be long enough for the hydrophilic groups to have a sufficient spacing to be able to act independently of one another. Gemini surfactants are generally distinguished by an unusually low critical micelle concentration and by an ability to reduce the surface tension of water to a considerable extent. In exceptional cases, however, gemini surfactants are not only understood to be “dimeric” surfactants, but also “trimeric” surfactants. Suitable gemini surfactants are, for example, sulfated hydroxy mixed ethers and dimer alcohol bis- and trimer alcohol tris-sulfates and -ether sulfates. End-capped dimeric and trimeric mixed ethers are distinguished in particular by their bifunctionality and multifunctionality. Thus, the end-capped surfactants mentioned exhibit good wetting properties and are low-foaming so that they are particularly suitable for use in machine washing or cleaning processes. However, gemini polyhydroxyfatty acid amides or poly-polyhydroxyfatty acid amides may also be used.

The detergents according to the invention additionally contain a builder system consisting of at least one organic and/or inorganic builder, the builders present preferably being at least partly introduced through the granules according to the invention.

Useful organic builders are, for example, polycarboxylic acids usable in the form of their sodium salts, polycarboxylic acids in this context being those carboxylic acids which carry more than one acid function. These include, for example, citric acid, adipic acid, succinic acid, glutaric acid, malic acid, tartaric acid, maleic acid, fumaric acid, sugar acids, amino-carboxylic acids, nitrilotriacetic acid (NTA)—providing its use is not ecologically unsafe—and mixtures thereof. Preferred salts are the salts of the polycarboxylic acids, such as citric acid, adipic acid, succinic acid, glutaric acid, tartaric acid, sugar acids and mixtures thereof.

The acids per se may also be used. Besides their builder effect, the acids also typically have the property of an acidifying component and, hence, also serve to establish a relatively low and mild pH value in detergents/cleaners. Citric acid, succinic acid, glutaric acid, adipic acid, gluconic acid and mixtures thereof are particularly mentioned in this regard.

Other suitable builders are polymeric polycarboxylates such as, for example, the alkali metal salts of polyacrylic or polymethacrylic acid, for example those with a relative molecular weight of 500 to 70,000 g/mole.

The molecular weights mentioned in this specification for polymeric polycarboxylates are weight-average molecular weights M_{w} of the particular acid form which, basically, were determined by gel permeation chromatography (GPC) using a UV detector. The measurement was carried out against an external polyacrylic acid standard which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

Particularly suitable polymers are polyacrylates which preferably have a molecular weight of 2,000 to 20,000 g/mole. By virtue of their superior solubility, preferred representatives of this group are the short-chain polyacrylates which have molecular weights of 2,000 to 10,000 g/mole and, more particularly, 3,000 to 5,000 g/mole.

Also suitable are copolymeric polycarboxylates, particularly those of acrylic acid with methacrylic acid and those of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weights, based on the free acids, are generally in the range from 2,000 to 70,000 g/mole, preferably in the range from 20,000 to 50,000 g/mole and more preferably in the range from 30,000 to 40,000 g/mole.

The (co)polymeric polycarboxylates may be used either in the form of an aqueous solution or in powder form. The detergents preferably contain 0.5 to 20% by weight and more particularly 3 to 10% by weight of (co)polymeric polycarboxylates.

In order to improve solubility in water, the polymers may also contain allyl sulfonic acids, such as for example allyloxybenzene sulfonic acid and methallyl sulfonic acid, as monomer.

Other particularly preferred polymers are biodegradable polymers of more than two different monomer units, for example those which contain salts of acrylic acid and maleic acid and vinyl alcohol or vinyl alcohol derivatives as monomers or those which contain salts of acrylic acid and 2-alkylailyl sulfonic acid and sugar derivatives as monomers.

Other preferred copolymers are those which are described in German patent applications DE-A-43 03 320 and DE-A-44 17 734 and which preferably contain acrolein and acrylic acid/acrylic acid salts or acrolein and vinyl acetate as monomers.

Other preferred builders are polymeric aminodicarboxylic acids, salts or precursors thereof. Particular preference is attributed to polyaspartic acids or salts and derivatives thereof which, according to German patent application DE-A-195 40 086, are also said to have a bleach-stabilizing effect in addition to their co-builder properties.

Other suitable builders are polyacetals which may be obtained by reaction of dialdehydes with polyol carboxylic acids containing 5 to 7 carbon atoms and at least three hydroxyl groups. Preferred polyacetals are obtained from dialdehydes, such as glyoxal, glutaraldehyde, terephthal-aldehyde and mixtures thereof and from polyol carboxylic acids, such as gluconic acid and/or glucoheptonic acid.

Other suitable organic builders are dextrins, for example oligomers or polymers of carbohydrates which may be obtained by partial hydrolysis of starches. The hydrolysis may be carried out by standard methods, for example acid- or enzyme-catalyzed methods. The end products are preferably hydrolysis products with average molecular weights of 400 to 500,000 g/mole. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose sirups with a DE of 20 to 37 and also so-called yellow dextrins and white dextrins with relatively high molecular weights of 2,000 to 30,000 g/mole may be used.

The oxidized derivatives of such dextrins are their reaction products with oxidizing agents which are capable of oxidizing at least one alcohol function of the saccharide ring to the carboxylic acid function. Dextrins thus oxidized and processes for their production are known, for example, from European patent applications EP-A-0 232 202, EPA-0 427 349, EP-A-0 472 042 and EP-A-0 542 496 and from International patent applications WO 92/18542, WO 93108251, WO 93/16110, WO 94128030, WO 95107303, WO 95/12619 and WO 95/20608. An oxidized oligosaccharide corresponding to German patent application DE-A-196 00 018 is also suitable. A product oxidized at C₆ of the saccharide ring can be particularly advantageous.

Other suitable co-builders are oxydisuccinates and other derivatives of disuccinates, preferably ethylenediamine disuccinate. Ethylenediamine-N,N′-disuccinate (EDDS) is preferably used in the form of its sodium or magnesium salts. Glycerol disuccinates and glycerol trisuccinates are also particularly preferred in this connection. The quantities used in zeolite-containing and/or silicate-containing formulations are from 3 to 15% by weight.

Other useful organic co-builders are, for example, acetylated hydroxycarboxylic acids and salts thereof which may optionally be present in lactone form and which contain at least 4 carbon atoms, at least one hydroxy group and at most two acid groups. Co-builders such as these are described, for example, in Iriternational patent application WO-A-95/20029.

Another class of substances with co-builder properties are the phosphonates, more particularly hydroxyalkane and aminoalkane phosphonates. Among the hydroxyalkane phosphonates, 1-hydroxyethane-1,1-diphosphonate (HEDP) is particularly important as a co-builder. It is preferably used in the form of a sodium salt, the disodium salt showing a neutral reaction and the tetrasodium salt an alkaline reaction (pH 9). Preferred aminoalkane phosphonates are ethylenediamine tetramethylene phosphonate (EDTMP), diethylenetriamine pentamethylene phosphonate (DTPMP) and higher homologs thereof. They are preferably used in the form of the neutrally reacting sodium salts, for example as the hexasodium salt of EDTMP and as the hepta- and octasodium salt of DTPMP. Within the class of phosphonates, HEDP is preferably used as builder. The aminoalkane phosphonates also show a pronounced heavy metal binding capacity. Accordingly, it can be of advantage to use aminoalkane phosphonates, more especially DTPMP, or mixtures of the phosphonates mentioned.

In addition, any compounds capable of complexing alkaline earth metal ions may be used as co-builders.

A preferred inorganic builder is finely crystalline, synthetic zeolite containing bound water, preferably zeolite A, X and/or P. A particularly preferred zeolite P is, for example, zeolite MAP (for example Doucil A24, a product of Crosfield). A co-crystallized sodium/potassium-aluminium silicate of zeolite A and zeolite X, which is marketed, for example, under the name of VEGOBOND AX® (by Condea Augusta S.p.A.), is also of particular interest. The zeolite may be used as a spray-dried powder or even as an undried stabilized suspension still moist from its production. Where the zeolite is used in the form of a suspension, the suspension may contain small additions of nonionic surfactants as stabilizers, for example 1 to 3% by weight, based on zeolite, of ethoxylated C₁₂₋₁₈ fatty alcohols containing 2 to 5 ethylene oxide groups, C₁₂₋₁₄ fatty alcohols containing 4 to 5 ethylene oxide groups or ethoxylated isotridecanols. Suitable zeolites have a mean particle size of less than 10 μm (volume distribution, as measured by the Coulter Counter method) and contain preferably 10 to 22% by weight and, more preferably, 15 to 22% by weight of bound water.

Suitable substitutes or partial substitutes for the zeolite are layer silicates of natural and synthetic origin. Layer silicates such as these are known, for example, from patent applications DE-B-23 34 899, EP-A-0 026 529 and DE-A-35 26 405. Their suitability is not confined to a particular composition or structural formula, although smectites and especially bentonites are preferred. Crystalline layer-form sodium silicates corresponding to the general formula NaMSiₓO₂ₓ₊₁.yH₂O, where M is sodium or hydrogen, x is a number of 1.9 to 4 and y is a number of 0 to 20, preferred values for x being 2, 3 or 4, are also suitable substitutes for zeolites and phosphates. Crystalline layer silicates such as these are described, for example, in European patent application EP-A-0 164 514. Preferred crystalline layer silicates corresponding to the above formula are those in which M is sodium and x assumes the value 2 or 3. Both β- and -δ-sodium disilicates Na₂Si₂O₅.yH₂O are particularly preferred.

Other preferred builders are amorphous sodium silicates with a modulus (Na₂O:SiO₂ ratio) of 1:2 to 1:3.3, preferably 1:2 to 1:2.8 and more preferably 1:2 to 1:2.6 which dissolve with delay and exhibit multiple wash cycle properties. The delay in dissolution in relation to conventional amorphous sodium silicates can have been obtained in various ways, for example by surface treatment, compounding, compacting or by overdrying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation which have a width of several degrees of the diffraction angle. Particularly good builder properties may even be achieved where the silicate particles produce crooked or even sharp diffraction maxima in electron diffraction experiments. This may be interpreted to mean that the products have microcrystalline regions between 10 and a few hundred nm in size, values of up to at most 50 nm and, more particularly, up to at most 20 nm being preferred. So-called X-ray amorphous silicates such as these, which also dissolve with delay in relation to conventional waterglasses, are described for example in German patent application DE-A-44 00 024. Compacted amorphous silicates, compounded amorphous silicates and overdried X-ray-amorphous silicates are particularly preferred.

The generally known phosphates may of course also be used as builders providing their use is not ecologically problematical. The sodium salts of orthophosphates, pyrophosphates and, in particular, tripoly-phosphates are particularly suitable. Their content is generally no more than 25% by weight and preferably no more than 20% by weight, based on the final detergent. In some cases, it has been found that tri-polyphosphates in particular, even in small quantities of up to at most 10% by weight, based on the final detergent, produce a synergistic improvement in multiple wash cycle performance in combination with other builders.

Among the compounds yielding H₂O₂ in water which serve as bleaching agents, sodium perborate monohydrate or tetrahydrate and sodium percarbonate are particularly important. Other useful bleaching agents are, for example, peroxypyrophosphates, citrate perhydrates and H₂O₂-yielding peracidic salts or peracids, such as perbenzoates, peroxophthalates, diperazelaic acid, phthaloiminoperacid or diperdodecane dioic acid. The content of bleaching agents in the detergents is from 0 to 30% by weight and more particularly from 5 to 25% by weight, perborate monohydrate or percarbonate advantageously being used.

In order to obtain an improved bleaching effect where washing is carried out at temperatures of 60° C. or lower, bleach activators may be incorporated. The bleach activators may be compounds which form aliphatic peroxocarboxylic acids containing preferably 1 to 10 carbon atoms and more preferably 2 to 4 carbon atoms and/or optionally substituted perbenzoic acid under perhydrolysis conditions. Substances bearing O-and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly tetraacetyl glycoluril (TAGU), N-acylimides, more particularly N-nonanoyl succinimide (NOSI), acylated phenol sulfonates, more particularly n-nonanoyl or isononanoyloxybenzenesulfonate (n- or iso-NOBS), carboxylic anhydrides, more particularly phthalic anhydride, acylated polyhydric alcohols, more particularly triacetin, ethylene glycol diacetate and 2,5-diacetoxy-2,5-dihydrofuran.

In addition to or instead of the conventional bleach activators mentioned above, so-called bleach catalysts may also be incorporated in the tablets. Bleach catalysts are bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and cobalt-, iron-, copper- and ruthenium-ammine complexes may also be used as bleach catalysts.

Suitable enzymes are those from the class of proteases, lipases, amylases, cellulases or mixtures thereof. Enzymes obtained from bacterial strains or fungi, such as Bacillus subtilis, Bacillus licheniformis and Streptomyces griseus, are particularly suitable. Proteases of the subtilisin type are preferred, proteases obtained from Bacillus lentus being particularly preferred. Enzyme mixtures, for example of protease and amylase or protease and lipase or protease and cellulase or of cellulase and lipase or of protease, amylase and lipase or of protease, lipase and cellulase, but especially cellulase-containing mixtures, are of particular interest. Peroxidases or oxidases have also proved to be suitable in some cases. The enzymes may be adsorbed to supports and/or encapsulated in membrane materials to protect them against premature decomposition.

In addition, components with a positive effect on the removability of oil and fats from textiles by washing (so-called soil repellents) may also be used. This effect becomes particularly clear when a textile which has already been repeatedly washed with a detergent according to the invention containing this oil- and fat-dissolving component is soiled. Preferred oil- and fat-dissolving components include, for example, nonionic cellulose ethers, such as methyl cellulose and methyl hydroxypropyl cellulose containing 15 to 30% by weight of methoxyl groups and 1 to 15% by weight of hydroxypropoxyl groups, based on the nonionic cellulose ether, and the polymers of phthalic acid and/or terephthalic acid known from the prior art or derivatives thereof, more particularly polymers of ethylene terephthalates and/or polyethylene glycol terephthalates or anionically and/or nonionically modified derivatives thereof. Of these, the sulfonated derivatives of phthalic acid and terephthalic acid polymers are particularly preferred.

The detergents may contain derivatives of diamino-stilbenedisulfonic acid or alkali metal salts thereof as optical brighteners. Suitable optical brighteners are, for example, salts of 4,4′-bis-(2-anilino-4-morpholino-1,3,5-triazinyl-6-amino)-stilbene-2,2′-disulfonic acid or compounds of similar composition which contain a diethanolamino group, a methylamino group, an anilino group or a 2-methoxyethylamino group instead of the morpholino group. Brighteners of the substituted diphenyl styryl type, for example alkali metal salts of 4,4′-bis-(2-sulfostyryl)-diphenyl, 4,4′-bis-(4-chloro-3-sulfostyryl)-diphenyl or 4-(4-chlorostyryl)-4′-(2-sulfostyryl)-diphenyl, may also be present. Mixtures of the brighteners mentioned above may also be used.

Dyes and perfumes are added to detergents to improve the aesthetic impression created by the products and to provide the consumer not only with the required washing performance but also with a visually and sensorially “typical and unmistakable” product. Suitable perfume oils or perfumes include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyl-oxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes which together produce an attractive perfume note are preferably used. Perfume oils such as these may also contain natural perfume mixtures obtainable from vegetable sources, for example pine, citrus, jasmine, patchouli, rose or ylang-ylang oil. Also suitable are clary oil, camomile oil, clove oil, melissa oil, mint oil, cinnamon leaf oil, lime blossom oil, juniper berry oil, vetiver oil, olibanum oil, galbanum oil and labdanum oil and orange blossom oil, neroli oil, orange peel oil and sandalwood oil. Detergents normally contain less than 0.01% by weight of dyes whereas perfumes/fragrances can make up as much as 2% by weight of the formulation as a whole.

The perfumes may be directly incorporated in the detergents although it can also be of advantage to apply the perfumes to supports which strengthen the adherence of the perfume to the washing and which provide the textiles with a long-lasting fragrance through a slower release of the perfume. Suitable support materials are, for example, cyclodextrins, the cyclodextrin/perfume complexes optionally being coated with other auxiliaries.

In order to improve their aesthetic impression, detergents may be-colored with suitable dyes. Preferred dyes, which are not difficult for the expert to choose, have high stability in storage, are not affected by the other ingredients of the detergents or by light and do not have any pronounced substantivity for textile fibers so as not to color them.

The bulk density of the advantageously granular detergents is preferably at least about 600 g/l and more particularly in the range from 650 to 1100 g/l. However, detergents with a lower bulk density can also be produced. In one particularly preferred embodiment, the detergents are built from granular individual components on the lines of a building block system.

The invention is illustrated by the following Examples.

### EXAMPLES

Production of granules of polyethylene glycol 4000

Polyethylene glycol with a molecular weight of 4000 was introduced through a two-component nozzle into the fluidized bed of a Glatt AGT 400 fluidized bed granulator. The polyethylene glycol was used in the form of flakes and melted; the nozzle air temperature was 100° C. Throughout the granulation process, the nozzle remained clear and the fluidized bed was operated without interruption for several hours.

The parameters of the fluidized bed were as follows:

| | | |
|---|---|---|
| feed air volume | 650 | m³/h |
| feed air temperature | 20° | C. |
| fluidized bed temperature | 30° | C. |
| liquid throughput | 25 | kg/h |
| nozzle air temperature | 100° | C. |
| base diameter | 40 | cm |

After discharge, the material retained by the sieve had the following properties:

| | | |
|---|---|---|
| bulk density | 540 | g/l |
| particle size distribution | | |
| >1.6 mm | 14% | |
| >1.0 mm | 37% | |
| >0.4 mm | 37% | |
| >0.2 mm | 12% | |
| <0.2 mm | <1% | |

The particles larger than 1.6 mm in size are automatically sieved out in the production unit and, after size reduction, are returned to the fluidized bed.

Production of C₆₋₁₈ fatty alcohol granules A melt of C₁₆₋₁₈ fatty alcohol was introduced into a fluidized bed at a nozzle temperature of 65° C. Fine-particle powder of polyethylene glycol 4000 had been introduced into the fluidized bed to start the granulation process (granulation nuclei). The fatty alcohol melt was continuously sprayed in.

The parameters of the fluidized bed were as follows:

| | | |
|---|---|---|
| feed air volume | 750 | m³/h |
| feed air temperature | 24° | C. |
| fluidized bed temperature | 32° | C. |
| liquid throughput | 30 | kg/h |
| nozzle air temperature | 65° | C. |
| base diameter | 40 | cm |

After discharge, the material retained by the sieve had the following properties:

| | | |
|---|---|---|
| bulk density | 435 | g/l |
| particle size distribution | | |
| >1.6 mm | 0.3% | |
| >1.0 mm | 1.2% | |
| >0.4 mm | 92.2% | |
| >0.2 mm | 5.3% | |
| <0.2 mm | <1% | |

The particles larger than 1.6 mm in size are automatically sieved out in the production unit and, after size reduction, are returned to the fluidized bed. The mean particle size can be partly adjusted through the temperature of the air used for spraying.

1. A process for the production of granules, characterized in that organic compounds are introduced in the form of a melt into a fluidized bed which has a temperature below the softening temperature of the substances to be granulated, granulated and optionally dried and in that the granules are discharged from the fluidized bed via a grading stage.

2. A process as claimed in claim 1, characterized in that the melt is introduced into the fluidized bed through one or more nozzles.

3. A process as claimed in claim 1 or 2, characterized in that the organic compounds are selected from the group consisting of thermoplastic polymers, polyethylene glycols, preferably with a melting point above room temperature, natural and synthetic fats, long-chain fatty acids, long-chain fatty alcohols, paraffins and long-chain nonionic surfactants.

4. A process as claimed in any of claims 1 to 3, characterized in that the melt is a mixture of several organic compounds.

5. A process as claimed in any of claims 1 to 4, characterized in that the melt contains solid constituents in a quantity of up to 20%, based on the weight of the melt.

6. A process as claimed in claim 5, characterized in that the solid constituents are selected from fine-particle carrier materials which simultaneously perform a builder function in a wash liquor.

7. A process as claimed in any of claims 1 to 6, characterized in that granulation is carried out in batches or continuously, preferably continuously.

8. A process as claimed in any of claims 1 to 7, characterized in that the fluidizing air flow rate is between 1 and 8 m/s and preferably between 1.5 and 5.5 m/s

9. A process as claimed in any of claims 1 to 8, characterized in that the bottom air temperature is preferably between 10 and 35° C. and more particularly between 10 and 25° C.; in a particularly preferred embodiment, the bottom air temperature is at least 5° C., preferably more than 10° C. and more particularly even more than 15° C. below the softening temperature of the organic substance.

10. A process as claimed in any of claims 1 to 9, characterized in that the temperature of the fluidizing air as measured about 5 cm above the base plate is well below the softening temperature of the organic substance(s), preferably more than 10° C. below the softening temperature and, more particularly, even more than 15° C. below the softening temperature of the organic substance(s).

11. A process as claimed in any of claims 1 to 10, characterized in that the air exit temperature is below the softening temperature of the granulated organic substance(s), more particularly at least 5° C. below the softening temperature.

12. A process as claimed in any of claims 1 to 11, characterized in that the granules obtained have a bulk density of 400 to 1,000 g/l and preferably in the range from 550 to 850 g/l.

13. A process as claimed in any of claims 1 to 12, characterized in that the granules obtained contain no particles below 50 μm in size and preferably no particles below 100 μm in size.

14. A process as claimed in any of claims 1 to 13, characterized in that the granules obtained are powdered.

15. Detergents containing granules produced by the process claimed in any of claims 1 to 14.
